(19) United States
(12) Patent Application Publication
(10) Pub. No.: US 2016/0176332 A1
(43) Pub. Date: Jun. 23, 2016

(54) MOTOR VEHICLE HEADLAMP, MOTOR VEHICLE HEADLAMP SYSTEM, MOTOR VEHICLE AND METHOD FOR OPERATING A MOTOR VEHICLE

(71) Applicant: GM GLOBAL TECHNOLOGY OPERATIONS LLC, Detroit, MI (US)

(72) Inventors: Philipp ROECKL, Aschaffenburg (DE); Ingolf SCHNEIDER, Russelsheim (DE); Frank LANGKABEL, Russelsheim (DE); Rouven HABERKORN, Darmstadt (DE)

(73) Assignee: GM GLOBAL TECHNOLOGY OPERATIONS LLC, Detroit, MI (US)

(21) Appl. No.: 14/974,196

(22) Filed: Dec. 18, 2015

(30) Foreign Application Priority Data
Dec. 22, 2014 (DE) 102014019344.6

(51) Int. Cl. B60Q 1/08; B60Q 1/16

(52) U.S. Cl. CPC B60Q 1/08; B60Q 1/16; B60Q 2300/20

(57) ABSTRACT

Motor vehicle headlamps are disclosed with at least one illuminant for a low-beam light, a high-beam light and an ambient light, which are designed for emitting light upwards relative to a road plane, wherein the ambient light is emittable combined with low-beam light and/or high-beam light.

### CROSS-REFERENCE TO RELATED APPLICATION

This application claims priority to German Patent Application No. 102014019344.6, filed Dec. 22, 2014 which is incorporated herein by reference in its entirety.

### TECHNICAL FIELD

The present disclosure pertains to a motor vehicle headlamp, a motor vehicle headlamp system, a motor vehicle and a method for operating a motor vehicle headlamp system having an ambient light emittable in combination with a low-beam light and/or high-beam light.

### BACKGROUND

Motor vehicle headlamps, motor vehicle headlamp systems, motor vehicles and methods for operating motor vehicle headlamp systems of the type mentioned at the outset are known in the prior art. In particular from the automotive industry it is generally known to provide different types of headlamps which are directed in a travelling direction and switchable to suit requirement such as for example low-beam light, high-beam light, fog lamps and the like. In addition to this it is known on the one hand to provide manually steerable headlamps, for example aiming at signs or in the case of off-road vehicles, for searching the terrain.

Of late, automatically controlled headlamps are also provided on the other hand, which are controlled either as a function of a travelled curve radius, a yaw rate or a transverse acceleration of the vehicle or which are coupled to a navigation system, which allows predictions regarding the type of road travelled. DE 10 2005 036 002 A1 discloses a method for controlling an illumination device of a vehicle driven by an operating person, which detects a viewing direction of the driver onto the road lying in front of the driver. At least one parameter of at least one settable and adjustable headlamp of the illumination device is set a as a function of the detected information regarding the viewing direction. Furthermore, a corresponding headlamp system is described.

Disadvantageous with the known methods is that viewing direction-controlled systems emit unsettled light distributions following the rapid viewing direction changes. The continuously changing light distributions resulting from this can irritate and negatively affect the driving safety. In addition, for example when reading a traffic sign that is usually provided relatively high up, a region can be swept with the light when looking up, in which oncoming traffic can be dazzled, so that the road safety of other road users is thereby impaired.

### SUMMARY

In accordance with the present disclosure, a motor vehicle headlamp, a motor vehicle headlamp system, a motor vehicle and a method for operating a motor vehicle headlamp system of the type mentioned at the outset so are developed which adapt emitted illumination without dazzling the oncoming traffic. The motor vehicle headlamp includes at least one illuminant for a low-beam light and a high-beam light. The motor vehicle headlamp system includes at least one headlamp arrangement, which is designed for emitting a variable light distribution. Furthermore, a driver monitoring device for detecting a viewing direction of a driver is provided.

According to a first aspect, a motor vehicle headlamp with at least one illuminant is described. Motor vehicle headlamps and illuminants are configured in such a manner that a low-beam light and a high-beam light can be emit. The same or different illuminants can be used for low-beam light and high-beam light. Furthermore, the motor vehicle headlamp and the at least one illuminant are configured for emitting an ambient light. The ambient light can be additionally switchable. An ambient light in the sense mentioned here is an illumination that is inclined outwards. The ambient light thus illuminates a region in which information that is relevant to the driver of a motor vehicle is arranged, for example on traffic signs.

It is provided, in addition, that the ambient light can be combined with low-beam light and/or high-beam light. Accordingly, the regular illumination can be maintained and complemented by the ambient light. Generally, the ambient light forms a separate illuminated zone to a low-beam light and in some configurations also to a high-beam light. In other configurations, the ambient light can expand the high-beam light upwards.

A first aspect provides that the ambient light, always with respect to a lower limit of the illuminated region, is inclined upwards with an angle of inclination of 2.5° and greater relative to a road plane. Alternatively to this, the ambient light can lie in an angle of inclination range of 4° upwards relative to the road plane and greater, in particular 5° and greater, with respect to a lower limit of the illuminated region. Thus, the oncoming traffic at usual distances, for example 25 m or greater, is not dazzled. The information relates to a headlamp that is regularly installed in a motor vehicle. The lower limit of the illuminated region can in some configurations have even greater angles of inclination to the road plane. The road plane in the case of roads that are not flat is defined by the contact patches of the tires on the road. In some configurations of the headlamp, the angle of inclination of the ambient light can be variable in order to prevent that oncoming traffic is dazzled-by the ambient light. Laterally, the ambient light can be delimited in such a manner that the oncoming traffic, which undershoots a certain distance from the own motor vehicle, is outside the ambient light.

The further possible aspect of the headlamp provides at least one optical element which in the light beam is subordinated to an illuminant. The optical element can be adjustable in order to vary the ambient light, in particular to activate and to deactivate the same and/or in order to set the angular range of the same relative to the road plane. According to a configuration, the optical element can be designed in order to activate the ambient light in that the optical element enables the light beam for the ambient light. Alternatively or additionally to this, the optical element can form the ambient light, that is define limits of the ambient light. Apart from this or additionally, the optical element can set the ambient light, for example change the position of the ambient light. This position change of the ambient light can be controlled as a function of the viewing direction.

In a further configuration of the headlamp, the optical element can include a diaphragm. Such a diaphragm can among other things be a modular diaphragm, a shutter diaphragm or a slit diaphragm. With the help of a diaphragm, regions of the ambient light can be defined. In particular slit diaphragms make possible defining a spatially limited ambient light.

According to a further aspect of the headlamp, the optical element can be arranged between the illuminant and a lens of the headlamp. In configurations, in which the headlamp includes a reflector between illuminant and lens, the optical element can be arranged between reflector and lens. Such an arrangement of the optical element can be carried out in a relatively well-encapsulated region of the headlamp, which ensures durable functioning.

Another further aspect of the headlamp provides that the headlamp is designed for fading-out part regions from the light distribution. In this way, an oncoming vehicle can for example be excluded from the light distribution in order not to dazzle the same. By activating the ambient light located high up however it can still be achieved that traffic signs for example which are above the oncoming motor vehicle, can be illuminated with the ambient light. Such fading-out of the oncoming traffic from the light distribution then no longer impairs the readability of traffic signs. In a high-beam light mode, the ambient light can merge with the regular illumination and expand the high-beam light distribution upwards.

According to another aspect of the headlamp, the same can include at least one matrix headlamp. The headlamp can be designed as matrix headlamp or in addition to the matrix headlamp include another headlamp. Matrix headlamps are headlamps which include a plurality of individual illumination elements which are variably switchable. Switchability can relate to groups or to individual illumination elements. With the help of matrix headlamps, a variable light distribution can be emitted, without having to make use of adjustable, for example pivotable headlamps. Matrix headlamps can be combined in particular with optical elements in order to activate an ambient light.

Another further aspect of the headlamp provides that for the ambient light at least one additional headlamp is provided. The additional headlamp can be suitably oriented in order to illuminate the corresponding angular range of 2.5° or greater upwards relative to a road plane based on the lower limit of the illuminated region.

According to a further aspect, the headlamp is equipped in order to activate the ambient light in a low-beam light mode. Accordingly, a corresponding ambient light can also be emitted when because of the traffic conditions no high-beam light is activatable. Since low-beam light is mainly directed downwards, a correspondingly oriented ambient light is particularly helpful since regions above the stated angular range are relative poorly illuminated or not at all.

A first independent subject relates to a motor vehicle headlamp system. The motor vehicle headlamp system includes at least one headlamp of the type mentioned before, which is designed for emitting a variable light distribution. The headlamp arrangement is designed in order to emit an ambient light upwards relative to a road plane. The ambient light is designed so that oncoming traffic is not dazzled. The angle of inclination relative to the road plane can be 2.5° and greater, in particular 4° and greater, in particular 5° and greater upwards, based on the lower limit of the illuminated region. The lower limit of the illuminated region can in some configurations have even greater angles of inclination relative to the road plane. In such angular ranges, illumination on the one hand of a traffic sign can be achieved while on the other hand dazzling oncoming traffic at usual distances can be avoided. Depending on the remaining setting of the headlamp, the ambient light can be a light region that is separated from the remaining light distribution.

Furthermore, a driver monitoring device for detecting a viewing direction of a driver is provided. With the help of the driver monitoring device a target or region of a driver's gaze can thus be determined.

Furthermore, a controller of the headlamp that is connected to the driver monitoring device is provided. The controller is equipped in order to activate the ambient light when a viewing direction of the driver is in an angular range of +2° or greater upwards relative to a road plane. Because of the fact that the ambient light can be activated when the driver suitably looks upwards, for example in order to detect a traffic sign, the illumination of regions located relatively far up can be improved so that detecting information in such regions located higher up is simplified. By activating the ambient light an unsettled illumination image can be additionally avoided, which possibly has an irritating effect.

According to a further aspect it can be provided that the viewing direction of the driver is in an angular range of 1.5° or greater. Usually, the headlamps are arranged lower than eyes of the driver, so that at the relevant distances there is an overlap of viewing direction and ambient light.

Furthermore, according to a configuration, the motor vehicle headlamp system can be equipped in such a manner that the angular difference between viewing direction and illumination direction resulting from the different positions is automatically compensated.

Another further aspect of the motor vehicle headlamp system provides that a camera facing in travelling direction is connected to the controller, wherein by means of the camera oncoming vehicles are detectable, wherein the controller is equipped in order to fade out the part region, in which the oncoming motor vehicle is located. With the help of a camera, oncoming motor vehicles can be reliably identified with the help of suitable detection algorithms. Additionally or alternatively to a camera, other systems, for example radar or lidar can be used. The detection of the motor vehicles can be implemented in the camera or in the controller.

A further aspect of the motor vehicle headlamp system provides that the controller is designed in order to actuate the optical element as a function of the viewing direction of the driver. Because of this, the ambient light can be activated among other things.

A further independent subject relates to a motor vehicle. The motor vehicle includes a motor vehicle headlamp system of the typed mentioned before.

A further independent subject described here relates to a method for operating a motor vehicle headlamp system. According to a first aspect, the motor vehicle headlamp system is designed for emitting a variable light distribution. A headlamp arrangement of the headlamp system is designed in order to emit an ambient light based on the lower limit of the illuminated region, in an angular range of 2.5° or greater upwards relative to a road plane. Such an ambient light can help improve detectability and readability of traffic signs.

Furthermore, a viewing direction of a driver is detected with a driver monitoring device, wherein by means of a controller the ambient light of the headlamp system is activated when a viewing direction of the driver is in an angular range of 2° or greater relative to the road plane. Accordingly, activation of the ambient light can take place as a function of the viewing direction.

A first further configuration of the method can provide that a moveable optical element in a headlamp of the motor vehicle headlamp system is actuated in such a manner that the ambient light falls in the viewing direction of the driver. The moveable optical element can be driven by means of an actuator, in particular an electric actuator. The optical element in this case can serve for activating or deactivating the ambient light of the headlamp. Additionally or alternatively it can serve for adapting the ambient light if the ambient light is adjustable.

According to a further aspect of the method, the headlamp can exclude a part region from the illumination. Thus, dazzling oncoming traffic can be avoided. In particular, the headlamp can exclude a part region from the normal illumination, for example a low-beam light or a high-beam light.

A further possible aspect of the method can provide that the ambient light is activated when the part region, which is excluded from the illumination, is in a viewing region of the driver. In this case a shadow can otherwise lie above the faded-out region, which worsens the readability of traffic signs in this region. By activating the ambient light, such a contrast situation can be avoided while dazzling of oncoming motor vehicles is nevertheless prevented.

A further aspect of the method provides that the headlamp system otherwise emits a low-beam light. In this way, two light regions that are separate from one another are defined by the low-beam light and by the ambient light, which avoid dazzling oncoming traffic yet makes possible the readability of traffic signs located high up.

A further aspect relates to a device for operating a motor vehicle headlamp system which is designed for emitting a variable light distribution, wherein the headlamp system includes means in order to emit an ambient light in an angular range of 2.5° or greater upwards relative to a road plane. Furthermore, a driver monitoring device is provided which is equipped in order to detect a viewing direction of a driver. By means of a controller that is connected to the driver monitoring device the means for activating the ambient light can be actuated. The controller is equipped in order to actuate the means when a viewing direction of the driver is in an angular range of 2.50 or greater relative to a road plane.

According to a first further aspect of the device, a moveable optical element can be provided in a headlamp of the motor vehicle headlamp system which can be actuated in such a manner that the ambient light of the headlamp is activatable and/or falls in the viewing direction of the driver.

According to a further aspect of the device, the headlamp can include means for excluding a part region from the illumination.

According to a further aspect of the present device it can be provided that the controller is equipped in order to activate the ambient light when the part region is in a viewing region of the driver.

A further aspect of the device provides that the headlamp arrangement is designed in order to otherwise emit a low-beam light.

### BRIEF DESCRIPTION OF THE DRAWINGS

The present disclosure will hereinafter be described in conjunction with the following drawing figures, wherein like numerals denote like elements.

FIG. 1 is a top view of a motor vehicle:

FIG. 2 shows a view from a cockpit of the motor vehicle from FIG. 1;

FIG. 3 shows the view from FIG. 2 with an oncoming motor vehicle;

FIG. 4 shows the view from FIG. 3 while viewing a sign bridge:

FIG. 5 is a schematic representation of a headlamp arrangement according to a first embodiment;

FIG. 6 is a schematic representation of a headlamp arrangement according to a second embodiment;

FIG. 7 is a schematic representation of a headlamp arrangement according to a third embodiment; and

FIG. 8 is a lateral view of the motor vehicle with a description of the different illumination zones.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

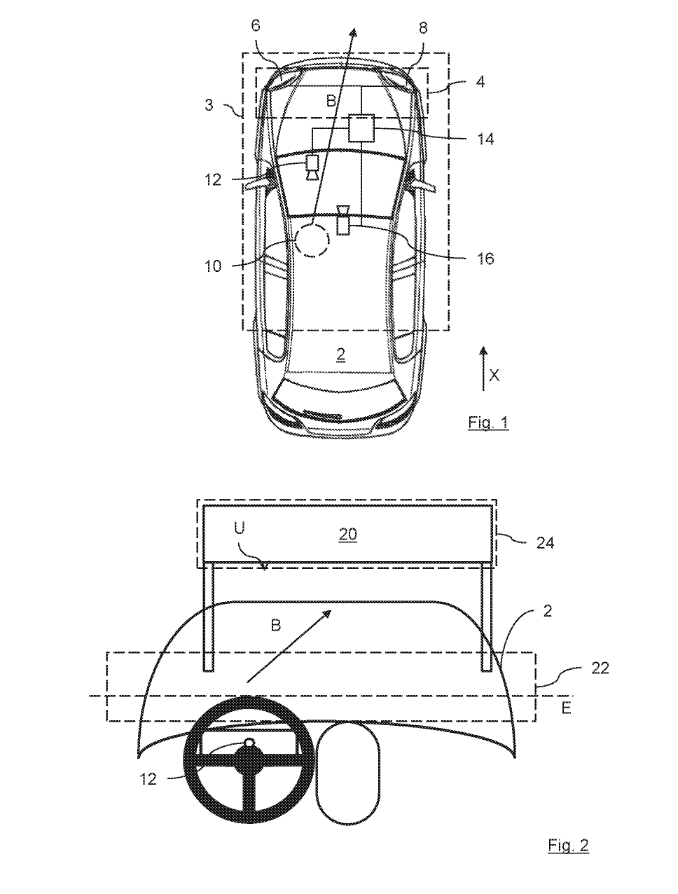

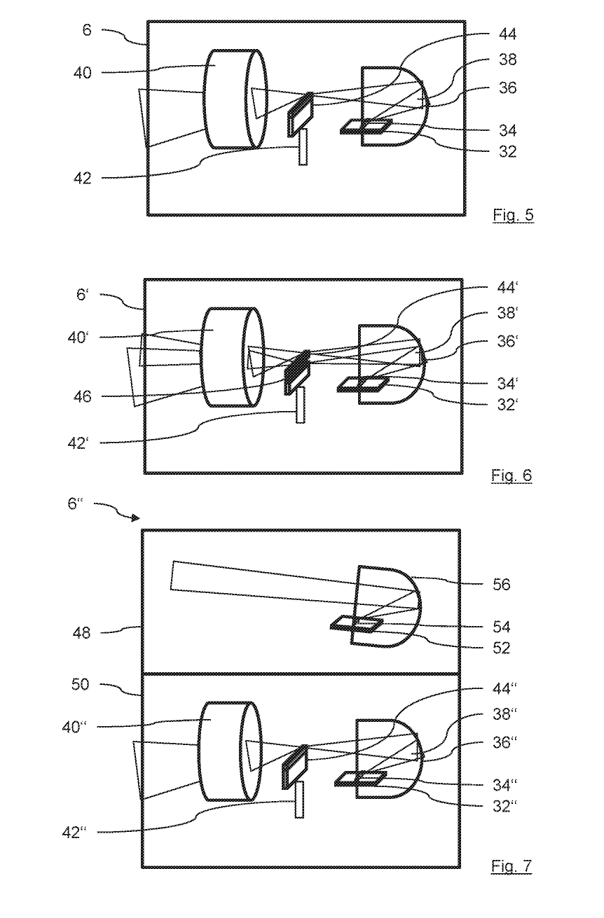

FIG. 1 shows a top view of a motor vehicle 2. The motor vehicle 2 includes a motor vehicle headlamp system 3 (framed in dashed line). The motor vehicle headlamp system 3 includes a headlamp arrangement 4 with headlamps 6, 8. The headlamps 6, 8 illuminate a region located in the travelling direction X in front of the motor vehicle 2. The headlamps 6, 8 are designed as matrix headlamps, which make possible a variable light distribution. Details of the possible configurations of the headlamps 6, 8 are shown in FIG. 5 to 7.

The motor vehicle 2 is driven by a driver 10 (shown in dashed line). The driver 10 is looking in a viewing direction B. Here, the viewing direction B on the one hand has an angle to the travelling direction X, on the other hand an angle to the road plane E. Accordingly, the driver 10 can look in different directions, straight ahead, to the left or right and simultaneously upwards, downwards or straight ahead. The viewing direction B of the driver 10 is detected with the help of a driver monitoring camera 12, which is directed at the driver 10. The driver monitoring camera 12 can for example detect the eyes of the driver 10 and from their position estimate the viewing direction B of the driver 10. Such a driver monitoring camera 12 can be arranged for example in an instrument panel of the motor vehicle 2.

Driver monitoring camera 12 and the headlamps 6, 8 are connected to a controller 14. The controller 14 is able to control the headlamps 6, 8 as a function of the input signals of the driver monitoring camera 12 and thus of the viewing direction B of the driver 10. When the driver 10 looks upwards in an angular range of 2.5° or greater relative to a road plane E, the controller 14 controls the headlamps 6, 8 in such a manner that an ambient light is activated, which facilitates detecting and possibly reading of information in an upper field of vision without dazzling the oncoming traffic.

Furthermore, a front camera 16 is provided which is oriented in travelling direction X. The front camera 16 is likewise connected to the controller 14. With the help of the front camera 16, oncoming traffic can be detected and the illumination of the headlamps 6, 8 adapted by changing the activation of the matrix elements of the headlamps 6, 8.

FIG. 2 shows a cockpit view of the motor vehicle 2. The motor vehicle 2 travels towards a sign bridge 20. The sign bridge 20 is located above a low-beam light region 22 and is normally un-illuminated. The sign bridge 20 is therefore difficult to read with conventional illumination systems in the low-beam light mode, since it is not directly illuminated.

By equipping the motor vehicle 2 with a suitable motor vehicle headlamp system 3, an ambient light 24 can be activated which illuminates the region of the sign bridge 20. The ambient light 24 is a region that is separate from the low-beam light region 22 and is above a zone, in which oncoming motor vehicles can be dazzled. This region is usually located above 2.5°, in particular 4°, in particular 5° relative to the road plane E, with respect to a lower limit U of the illuminated region.

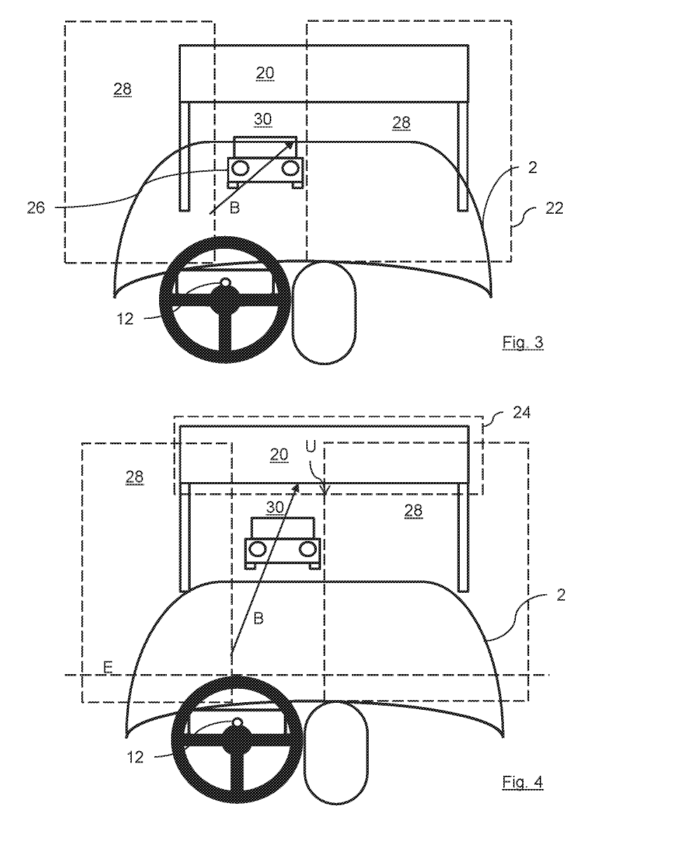

FIG. 3 shows an illumination situation with an oncoming motor vehicle 26. The headlamps 6, 8 are operated in a high-beam light mode, in which a high-beam light region 28 is illuminated. The viewing direction B of the driver 10 falls into the high-beam light region 28. From the high-beam light region 28, a part region 30 is excluded, in which the motor vehicle 26 is located. In this way, dazzling of the oncoming motor vehicle 26 is prevented.

FIG. 4 shows the view from FIG. 3, wherein the viewing direction B faces upwards in the direction of the sign bridge 20 by more than 2.5° relative to the road plane E. The viewing direction B is recognized by the driver monitoring camera 12 and the ambient light 24 activated. The illumination that is thereby created allows excluding the part region 30 about the motor vehicle 26 but good readability of the sign bridge 20 by way of the ambient light 24 falling thereon at the same time.

FIG. 5 shows a first possible embodiment of the headlamp 6. The headlamp 6 includes an LED-board 32 with a plurality of LEDs 34. The LEDs 34 can be individually activated in order to generate different light distributions, namely low-beam light 22, high-beam light 28 and the previously described ambient light 24. The headlamp 6 is designed in order to exclude part regions from the light distribution so as not to dazzle the oncoming traffic for example in a high-beam light mode. Ambient light 24 and low-beam light 22 or high-beam light 28 can be activated together. The LEDs 34 shine onto a reflector 36, from where a light beam 38 falls onto a lens 40, which forms the light beam 38. Between reflector 36 and lens 40 a diaphragm 44 that is adjustable by means of a motor 42 is provided, which can be brought into the light beam and can suitably reshape the light beam 38 in order to generate the ambient light 24.

FIG. 6 shows a second embodiment of a headlamp 6′. The headlamp 6′ can likewise generate low-beam light 22, high-beam light 28 and an ambient light 24. The headlamp 6′ includes a diaphragm 44′ with a slit 46. The diaphragm 44′ is laterally offset so that light falls past the diaphragm 44′. This light forms the normal low-beam light. Light, which falls through the slit 46 of the diaphragm 44′, is shaped by the diaphragm 44′ in such a manner that the ambient light 24 is thereby formed. The diaphragm 44′ is adjustable by means of a motor 42′ and/or activatable by activation of the matrix illumination elements.

FIG. 7 shows a further embodiment of a headlamp 6″. The headlamp 6″ can also generate low-beam light 22, high-beam light 28 and an ambient light 24. The headlamp 6″ includes two separate headlamp parts 48, 50, of which the headlamp part 48 is designed for generating the ambient light 24. The headlamp part 48 includes an LED-board 52 with LEDs 54, the light of which is reflected by a reflector 56 in travelling direction X in an angular range greater than 5° relative to a road plane E. The headlamp part 50 includes an LED-board 32″ with a plurality of LEDs 34″. The LEDs 34″ can be individually activated in order to generate different light distributions. The LEDs 34″ shine onto a reflector 36″, from where a light beam 38″ falls onto a lens 40″, which shapes the light beam 38″. Between reflector 36″ and lens 40″, a diaphragm 44″ that is adjustable by means of a motor 42″ is provided, which can be brought into the path of light and which can suitably re-shape the light beam 38″.

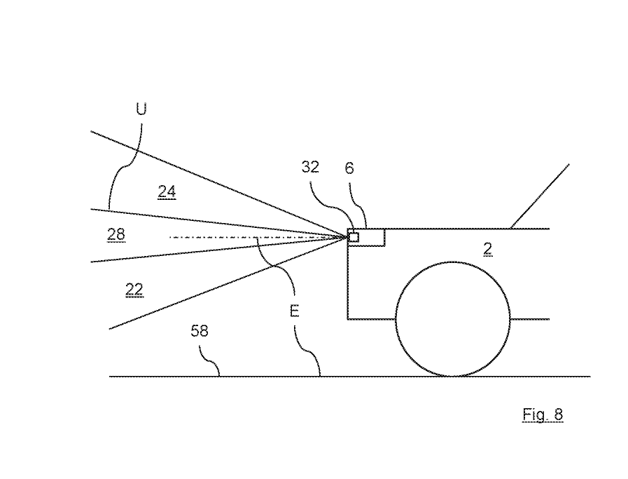

FIG. 8 shows a lateral view of the motor vehicle 2 with a description of the different illumination zones. The motor vehicle 2 stands on a road 58, which defines a road plane E. The road plane E is a reference for adjusting the headlamp 6. The low-beam light region 22 is slightly inclined downwards relative to the road plane E. The high-beam light region 28 follows the low-beam light region 22. The high-beam light region 28 can also overlap with the low-beam light region 22. An upper limit of the high-beam light region 28 is usually located in an angular range of 2.5° upwards relative to the road plane E. The ambient light 24 covers an even higher region, which is selected so that it does not dazzle oncoming traffic. A lower limit U of the ambient light 24 in the shown embodiment is at 2.5°. The lower limit U can even be higher in some configurations, in particular at 4° or 5°. Thus, illumination of traffic signs and the likes is possible at relevant distances. In some configurations, the lower limit U can be variable.

Ambient light 24 and low-beam light 22 and/or high-beam light 28 are combinable, so that the ambient light 24 is combinable with the low-beam light 22, with the high-beam light 28 or with low-beam light 22 and high-beam light 28. In a combination of ambient light 24 and low-beam light 22, two separate light zones are created, high-beam light 28 and ambient light 24 can form a common light zone or likewise two separate light zones.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1-15. (canceled)

16. A motor vehicle headlamp comprising at least one illuminant for a low-beam light, a high-beam light and an ambient light, wherein the ambient light is configured to emit a light distribution upwards relative to a road plane in combination with at least one of the low-beam light and the high-beam light.

17. The motor vehicle headlamp according to claim 16, wherein a lower limit of the ambient light is inclined upwards with an angle of inclination of 2.5° or greater relative to the road plane.

18. The motor vehicle headlamp according to claim 16, further comprising at least one adjustable optical element for the ambient light, which is subordinated to the illuminant in the path of light.

19. The motor vehicle headlamp according to claim 18, wherein the optical element comprises a diaphragm.

20. The motor vehicle headlamp according to claim 16, wherein the headlamp is configured to fade out a selected region from the light distribution.

21. The motor vehicle headlamp according to claim 16 wherein the at least one illuminant comprises at least one matrix headlamp.

22. The motor vehicle headlamp according to claim 16, further comprises at least one first illuminant for the low beam light and the high beam light, and at least one second illuminant for the ambient light.

23. A headlamp system for a motor vehicle comprising:
at least one motor vehicle headlamp according to claim 16;
at least one driver monitoring device for detecting a viewing direction of a driver; and
a controller for the motor vehicle headlamp in communication with the driver monitoring device and configured to activate the ambient light when the viewing direction of the driver is in an angular range equal or greater than +2° relative to a road plane.

24. The headlamp system according to claim 23, further comprising a camera configured to face in a travelling direction of the motor vehicle in communication with the controller, wherein the camera is configured to located an oncoming motor vehicle, and the controller is configured to fade out a selected region of the light distribution in which the oncoming motor vehicle is located.

25. The motor vehicle headlamp according to claim 23, wherein motor vehicle headlamp further comprises at least one optical element for the ambient light, which is subordinated to the illuminant in the path of light, wherein the controller is configured to actuate the at least one optical element as a function of the viewing direction of the driver.

26. A motor vehicle comprising a vehicle body supporting a headlamp system according to claim 23.

27. A method for operating a motor vehicle headlamp system configured to emit a variable light distribution comprising:
emitting at least one a beam light from a motor vehicle headlamp;
detecting a viewing direction of a driver with a driver monitoring device; and
selectively emitting an ambient light in combination with the at least one beam light, wherein the ambient light is directed upwards relative to a road plane; wherein the ambient light is activated by a headlamp controller when the viewing direction of the driver is in an angular range equal to or greater than 2° relative to the road plane.

28. The method according to claim 27 wherein selectively emitting an ambient light further comprises directing the ambient light with a moveable optical element in the headlamp in such a manner that the ambient light falls in the viewing direction of the driver.

29. The method according to claim 28, wherein selectively emitting an ambient light further comprises excluding a selected region of the ambient light from the illumination.

30. The method according to claim 28, wherein the ambient light is activated when the selected region is in a viewing region of the driver.
